(19) United States
(12) Patent Application Publication
(10) Pub. No.: US 2002/0091507 A1
(43) Pub. Date: Jul. 11, 2002

(54) Logic emulator with routing chip providing virtual full-crossbar interconnect

(76) Inventor: Tan Tseng, Redwood City, CA (US)

Correspondence Address: STUART T AUVINEN, 429 26TH AVENUE, SANTA CRUZ, CA, 95062-5319, US

(21) Appl. No.: 09/681,103

(22) Filed: Jan. 5, 2001

(51) Int. Cl. G06F 9/455

(52) U.S. Cl. 703/24; 703/25

(57) ABSTRACT

A hardware-based logic emulator uses routing chips to implement a virtual full-crossbar interconnect. Logic gates and some internal interconnection of the emulated design are programmed into field-programmable gate array (FPGA) logic chips. External interconnection of the logic chips is provided by routing chips. When the routing chips are also FPGA chips with a same number of I/O pins, the number of routing chips can be 1.5 times the number of logic chips. For L logic chips, the first L routing chips are column routing chips. The column routing chips connect to the same pin or pins of all the logic chips and make connections within a single column of a routing table. The other L2 routing chips are diagonal routing chips that connect to different pins on different logic chips. The diagonal routing chips make connections among logic chips along diagonals in the routing table.

### BACKGROUND OF INVENTION

This invention relates to logic-emulation systems, and more particularly to routing networks in logic emulators using field-programmable gate arrays (FPGA's).

Increasing complexity of digital circuits and systems has increased debug difficulty. Software-based simulators may be used to validate or test designs before manufacturing silicon prototypes, but the extent of the testing is limited by the relatively slow speed of the software simulator. Although software simulators are relatively inexpensive, they are slow since they simulate the logic gates of the design using routines of instructions such as single-bit write and test instructions. Logical states of nodes may have to be stored in a main memory or even on a hard disk, further slowing simulation. Complex designs such as microprocessors often require millions of test vectors which can occupy days or weeks of software simulation time.

Design validation can be accelerated by using higher-speed hardware-based emulators. These emulators allow millions of test vectors to be executed before a silicon prototype is manufactured. Actual application programs for the target design can be executed on the hardware-based emulator. Hardware-based emulators are commercially available from companies such as IKOS Systems of Cupertino, Calif., Aptix Corp. of San Jose, Calif., and Quickturn Systems of San Jose, Calif.

These hardware-based emulators emulate the design's logic gates using real hardware logic gates in a field-programmable gate array (FPGA) rather than with logical instructions executed on a microprocessor. FPGA's are commercially available from such firms as Altera of San Jose, Calif., Xilinx of San Jose, Calif., and Actel of Sunnyvale, Calif.

Hardware emulators use FPGA's for interconnection as well as for the logic gates being emulated. For example, U.S. Pat. No. 5,352,123 by Sample et al. and assigned to Quickturn Systems of San Jose, Calif. shows a multi-board emulator with FPGA chips for both logic emulation and for interconnecting other FPGA's.

The interconnection network implemented by the routing chips can be a full crossbar switch or network, where any pin on any FPGA logic chip can be connected to any other pin on any other FPGA logic chip. While routing flexibility is maximized with the full crossbar switch, cost is high since many routing chips are needed, usually many more than the number of logic chips.

The interconnection architectures in U.S. Pat. Nos. 5,352,123 and 5,414,638 provide interconnection from any pin of a user component to any pin of another user component. Using many interconnection chips increases timing delays, chip counts, and board space, resulting in a slower, larger, complicated and expensive system.

A reduced crossbar switch known as a partial crossbar was disclosed by Butts et al. in U.S. Pat. No. 5,448,496, and assigned to Quickturn Design Systems of San Jose, Calif. This partial crossbar switch uses one routing chip for each FPGA logic chip. Although the number of routing chips is greatly reduced, the partial crossbar suffers from severely restricted routing options. Many designs are not routable with the partial crossbar due to its restricted routing resources.

FIG. 1 is a diagram of a prior-art hardware-based emulator using routing chips arranged as a partial crossbar switch for interconnection. An emulation board contains several FPGA logic chips 12, 14, 16, 18 which are programmed to contain some or all of the logical gates in a design being emulated. These logical gates are connected together internally within each FPGA logic chip 12, 14, 16, 18 using internal interconnect, but some gates must be connected to gates in other FPGA logic chips 12, 14, 16, 18.

To perform this external interconnect, other FPGA chips are used as switch or routing chips 22, 24, 26, 28. Routing chips 22, 24, 26, 28 are simply used for interconnecting FPGA logic chips 12, 14, 16, 18 to each other and perhaps to other boards (not shown). Any logic gates within routing chips 22, 24, 26, 28 are generally not used since routing chips 22, 24, 26, 28 simply function as a partial cross-bar switch.

Routing chip 22 is used to connect pin A of FPGA logic chip 12 to pin A of the other FPGA logic chips 14, 16, 18. Likewise, routing chip 24 connects to pin B of all FPGA logic chips 12, 14, 16, 18. Routing chip 26 connects to pin C of all FPGA logic chips 12, 14, 16, 18, while routing chip 28 connects to pin D of all FPGA logic chips 12, 14, 16, 18.

The partial crossbar interconnect assumes that any logic gate can be connected to any of the four pins (A, B, C, D) of a logic chip, since the logic chips are programmable. Thus a logic gate in chip F2 (FPGA logic chip 14) can be programmed to drive pin B of chip F2. Routing chip 24 receives pin B from chip F2, and can be programmed to drive the signal received from pin B of chip F2 to FPGA logic chips 12, 18 (Fl, F4). The signal from F2 is then sent through routing chip 24 to chips Fl, F4. Logic chips Fl, F4 are programmed to route the input from pin B to inputs of logic gates in these chips that must receive the input, according to the design netlist or schematic.

Other external nets can be programmed using pins A, C, D and routing chips 22, 26, 28. This allows for some external connection among FPGA logic chips 1 2, 14, 16, 18 using routing chips 22, 24, 26, 28.

Such hardware emulators can be re-programmed to emulate other designs, and thus can be re-used over and over again. However, such emulators are expensive and can cost hundreds of thousands or millions of dollars. The reduced crossbar interconnection reduces cost, since the number of routing chips 22, 24, 26, 28 can equal the number of FPGA logic chips 12, 14, 16, 18. A full crossbar requires many more routing chips, often proportional to the square of the number of logic chips.

The example of FIG. 1 is simplified since each FPGA logic chip 12, 14, 16, 18 has only 4 pins—A, B, C, D, and each routing chip 22, 24, 26, 28 also has only 4 pins—1, 2, 3, 4. Actual FPGA chips can have 64, 128, or more interconnect pins rather than the 4 shown in this simplified example.

Designs in netlist form can be read, synthesized, partitioned and loaded into multiple FPGA's using an FPGA compiler such as Altera's MAXPLUS II. A report file from the compiler specifies the interconnection between FPGA chips. The system can then be prototyped by programming the FPGA's and routing chips with the interconnection specified by the report file.

FIG. 2 is a routing table for the partial crossbar emulator of FIG. 1. Each row of the table represents a different FPGA logic chip 12, 14, 16, 18 (F1, F2, F3, F4 in rows 1, 2, 3, 4). The columns represent the pins of the logic chips—pin A is column 1, pin B is column 2, pin C is column 3, and pin D is column 4.

For the partial crossbar, each routing chip is connected to the same pin of each FPGA logic chip. For example, routing chip 22 connects to pin A of logic chips Fl, F2, F3, F4. Thus the cells in column 1 are labeled RC1 for routing chip 1. Likewise, third routing chip 26 connects to pin C of all four logic chips, so cells in column 3 are labeled RC3.

The table indicates that routing chip RC1 can connect any pin A of any logic chip to pin A of any other logic chip. Routing chip RC4 can connect pin D of any logic chip to pin D of any other routing chip. Routing chip RC4 cannot, however, connect pin D of one logic chip to pin A of another logic chip.

FIG. 3 shows a routing table with programmed interconnections for a programmable design. The example design has 6 external connections—X1 to X6. These external connections must go through the routing chips to connect pins of the FPGA logic chips.

Routing chip 22 (RC1) is used to make connection X1, between pins A of logic chips F2 and F3. This is shown in the first column of the table. Connection X2 is made by routing chip 24 (RC2), between pin B of logic chips Fl and F3. Connection X3 is between pin C of logic chips Fl, F3, and uses routing chip 26 (RC3), while connection X4 between pin D of logic chips F2, F3 uses routing chip 28 (RC4).

These successful connections X1-X4 are shown in the table. However, two more connections—X5 and X6—still need to be made. Connections X5 and X6 are both between logic chips Fl and F2. However, no column in the table has empty cells for both rows 1 and 2 (F1 and F2). The empty cells represent unused pins of a logic chip.

Additional connections could be made using the empty cells. For example, empty cells exist in column 1 for logic chips F1, F4. A connection could be made using routing chip 22 (RC1) between logic chips F1, F4. This is a second connection using routing chip 22 (RC1). However, a connection cannot be made between logic chips F1 and F2 using RC1. Although a connection to pin A of logic chip F1 could be made by RC1, a connection to pin A of logic chip F2 has already been made for connection X1. Pin A of chip F2 is already in use for a different external connection net, and is not available. The routing resource is already in use.

Since there is no one column with empty cells for both F1 and F2, the design cannot be routed. Connections X5 and X6 are left unconnected. The partial crossbar interconnect fails to route the design. Instead, a larger emulator must be used, such as an emulator with 8 logic chips and 8 routing chips.

While the partial crossbar interconnect is successful at reducing the number of routing chips needed for an emulator, some designs cannot be successfully routed. The partial crossbar has limited routing resources, causing some designs to fail to be routed. A more flexible interconnect network is desired that still has reduced costs compared with a full crossbar, but has success at routing interconnect than the partial crossbar.

### BRIEF DESCRIPTION OF DRAWINGS

FIG. 1 is a diagram of a prior-art hardware-based emulator using routing chips arranged as a partial crossbar switch for interconnection.

FIG. 2 is a routing table for the partial crossbar emulator of FIG. 1.

FIG. 3 shows a routing table with programmed interconnections for a programmable design.

FIG. 4 is a diagram of a logic emulator with a virtual full-crossbar interconnection using routing chips.

FIGS. 5A, 5B are routing tables illustrating connection of the column and diagonal routing chips of the virtual full-crossbar emulator.

FIG. 6 is an example of a routing table for the virtual full-crossbar emulator.

FIG. 7 is an example of a design that is not routable using a prior-art partial crossbar emulator.

FIG. 8 is a routing table showing successful routing using the virtual full-crossbar emulator.

FIG. 9 is another example of a design that is not routable using the prior-art partial crossbar emulator.

FIG. 10 is a routing table showing the successful routing using the virtual full-crossbar emulator.

FIG. 11 is an example of shuffling connections to attempt to route a prior-art partial crossbar emulator.

FIG. 12 shows diagonal routing of the example of FIG. 11.

FIG. 13 shows a routing table for a prior-art partial-crossbar emulator with 8 logic chips.

FIG. 14 is a routing table for a virtual full-crossbar emulator with 8 logic chips and 12 routing chips.

FIG. 15 is a routing table for a virtual full-crossbar emulator having 16 logic chips with 16 pins per chip.

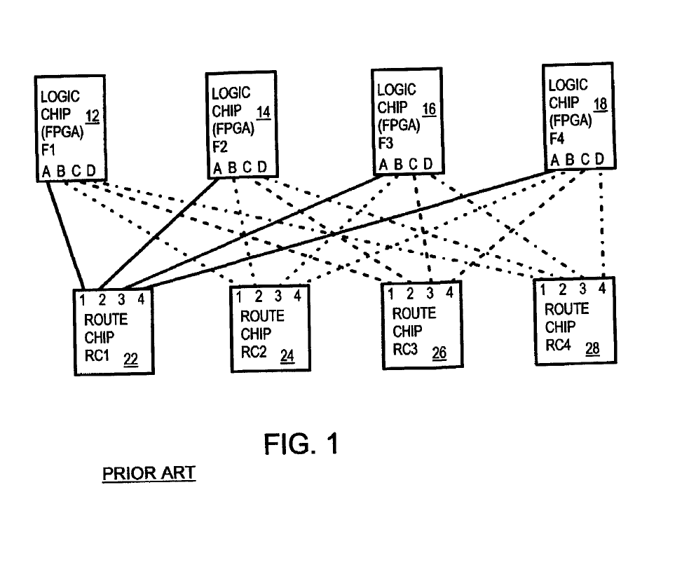

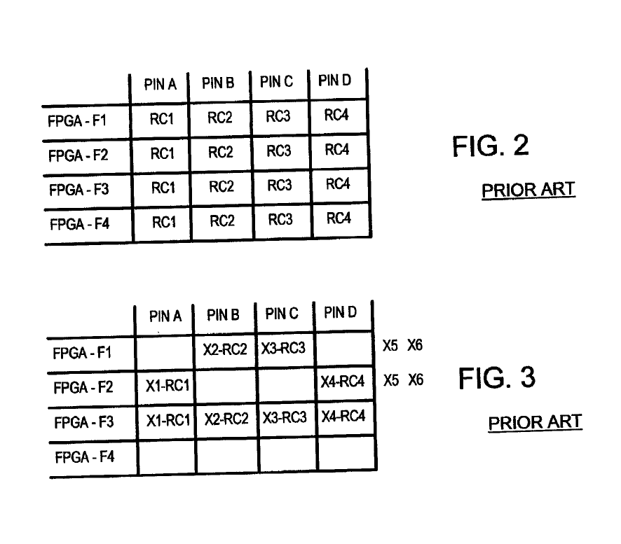

### DETAILED DESCRIPTION

The present invention relates to an improvement in hardware-based logic emulators. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

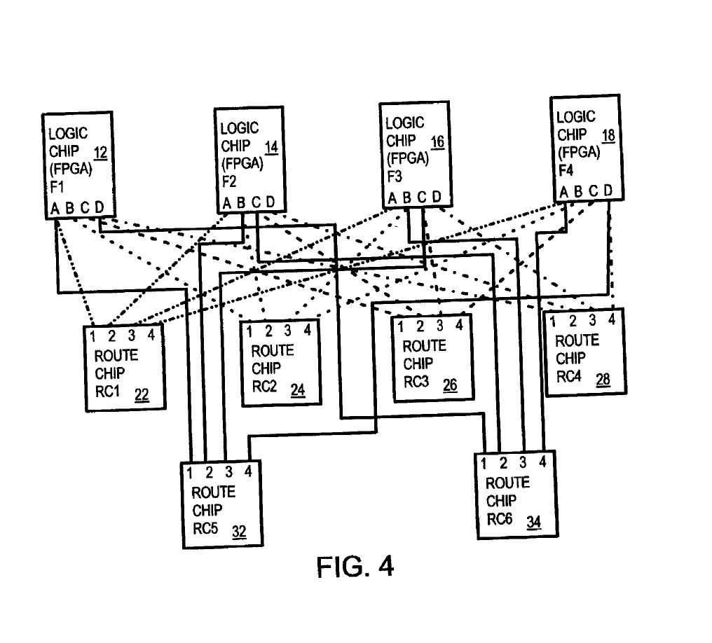

FIG. 4 is a diagram of a logic emulator with a virtual full-crossbar interconnection using routing chips. The logic emulator includes field-programmable gate array (FPGA) logic chips 12, 14, 16, 18 which contain programmed logic gates to implement a target design being emulated. Routing chips 22, 24, 26, 28, 32, 34 can also be programmable logic chips such as FPGA's, or more specialized programmable chips for implementing programmable interconnect or routing. Any logic gates in routing chips 22, 24, 26, 28, 32, 34 are not used, except perhaps for buffers that do not logically alter the data.

A host system (not shown) contains a schematic or netlist of the design to be emulated. The FPGA logic chips 12, 14, 16, 18 are programmed to enable the desired logic gates by commands from the host that are downloaded from the host to FPGA logic chips 12, 14, 16, 18, usually through specialized programming signals or busses. The host also programs routing chips 22, 24, 26, 28, 32, 34 to make the desired connections. The chips can exist on one printed-circuit board (PCB) substrate, or can be mounted on several board substrates that are connected together.

Since many designs have more logic gates than are available on any one FPGA logic chip, the design is partitioned among several FPGA logic chips 12, 14, 16, 18, using specialized design-partitioning software. Routing chips 22, 24, 26, 28, 32, 34 are programmed to externally interconnect logic gates in FPGA logic chips 12, 14, 16, 18.

Routing chips 22, 24, 26, 28 are each connected to the same pins from each FPGA logic chip 12, 14, 16, 18. For example, routing chip 22 (RC1) has four pins (1, 2, 3, 4) that connect to pin A of FPGA logic chips 12, 14, 16, 18. Routing chip 28 (RC4) connects to pin D of each logic chip. Routing chips 22, 24, 26, 28 are column-based routing chips, since they connect to the same pin on each logic chip, and are able to only connect together the same pin on different logic chips.

Two additional routing chips 32, 34 are added. Routing chip 32 (RC5) connects to pin A of logic chip F1 (FPGA logic chip 12), pin B of logic chip F2, pin C of logic chip F3, and pin D of logic chip F4. Routing chip 34 (RC6) connects to pin D of logic chip F1 (FPGA logic chip 12), pin C of logic chip F2, pin B of logic chip F3, and pin A of logic chip F4.

Since routing chips 32, 34 connect to a different pin of each FPGA logic chip, they are diagonal routing chips, while routing chips 22, 24, 26, 28 are column routing chips. The diagonal routing chips 32, 34 increase routing flexibility, since they can route otherwise un-routable designs. They increase the usage of the same number of FPGA logic chip pins relative to the partial crossbar interconnect.

Note that the number of FPGA logic chips 12,14,16,18 has remained the same, and the number of pins on FPGA logic chips 12,14,16, 18 has also remained the constant. The number of routing chips has increased by 2-50%. The increased cost of the virtual full-crossbar emulator over the partial crossbar emulator is the cost of 50% more routing chips.

Routability is improved without increasing the number of FPGA logic-chip pins. Each pin is connected to two routing chips, one column routing chip and one diagonal routing chip. For example, pin A of logic chip 12 is connected to column routing chip 22 and also to diagonal routing chip 32. This improves the likelihood of there being an available routing chip connected to the logic chip.

The emulator using the diagonal routing chips as well as the column routing chips is referred to as a virtual full-crossbar emulator. A full-crossbar emulator requires many more routing chips, such as 16 for the example of 4 logic chips with 4 pins. The virtual full-crossbar achieves the same routability as the full crossbar, with fewer routing chips.

In actual emulators, the number of pins on each chip is larger than in the simplified examples. FPGA chips with 32, 64, 128, or other numbers of interconnect pins are possible. An emulator often has many more FPGA logic chips, such as 100 or 1,000 logic chips. The ratio of routing chips to logic chips can vary when the routing chips have a different number of pins than the logic chips. Logic and routing chips of different capacities can also be mixed in one system.

For a more realistic emulator with 100 logic chips, and routing chips with the same number of I/O pins as the logic chips, a virtual full-crossbar interconnect can be constructed with 150 routing chip. A full crossbar could require as many as 100*100 or 10,000 routing chips. Thus the number of routing chips is reduced significantly, from 10,000 to 150.

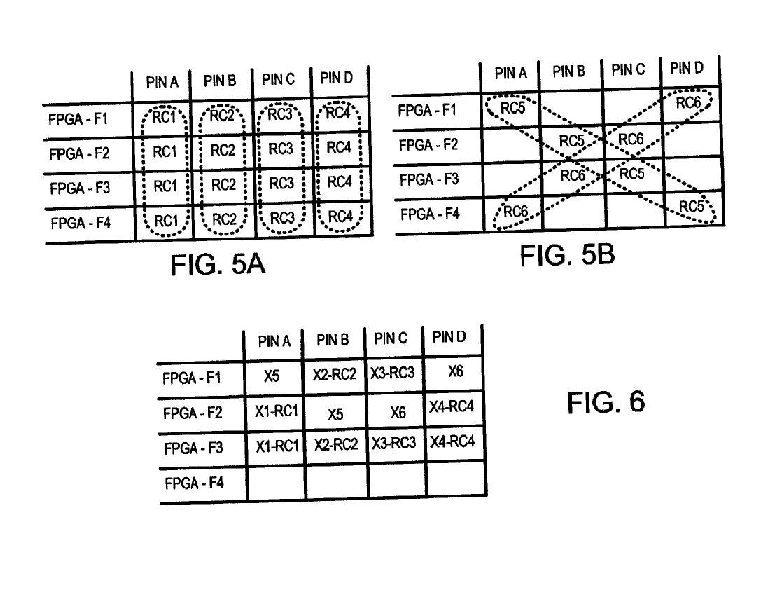

FIGS. 5A, 5B are routing tables illustrating connection of the column and diagonal routing chips of the virtual full-crossbar emulator. FIG. 5A shows connection of the column routing chips 22, 24, 26, 28 (labeled RC1, RC2, RC3, RC4) to FPGA logic chips 12, 14, 16, 18. Routing chip 22 (RC1) is able to make connections among all four logic chips using pin A from each chip. For example, one connection can be made connecting all four chips, or two separate connections could be made, one connecting chips F1 and F2, and the other connection between logic chips F3 and F4.

While the column routing chips are useful, they are limited since they can only make connections with the same pin of different logic chips. Thus routing chip 26 (RC3) cannot make a connection between pin A of one logic chip, and pin C of another. Connections using routing chip 26 (RC3) can only be made with the same pin, or among cells in the same column (3) of the table.

FIG. 5B shows connection of the diagonal routing chips 32, 34. Diagonal routing chips 32, 34 overcome the limitation of the column routing chips by connecting to different pins of each logic chip. For example, diagonal routing chip 32 (RC5) connects to pin A of logic chip 12 (F1), pin B of logic chip 14 (F2), pin C of logic chip 16 (F3) and pin D of logic chip 18 (F4). This is shown in the routing table as a diagonal line of cells labeled RC5.

For example, all four logic chips F1-F4 could be connected together by routing chip 32 (RC5) through pin A of F1, represented by the upper-left cell, pin B of F2, represented by the second cell in row F2, pin C of F3, represented by the third cell of row F3, and pin D of F4, represented by the last cell of row F4. Only two or three of these cells could be connected together rather than all four, and two separate connections could also be made, such as pin A of F1 and pin D of F4, and a second connection of pin B of F2 and pin C of F3.

A second diagonal routing chip also provides flexibility by connecting to different pins of different chips. Diagonal routing chip 34 (RC6) connects to pin D of logic chip 12 (F1), pin C of logic chip 14 (F2), pin B of logic chip 16 (F3) and pin A of logic chip 18 (F4). This is shown in the routing table as a reverse diagonal line of cells labeled RC6, from the lower-left to the upper-right.

The two tables of FIGS. 5A, 5B are actually one table, since all 6 routing chips are part of the same emulator. Thus the diagonal table of FIG. 5B should be superimposed over the column table of Fig. 5A.

FIG. 6 is an example of a routing table for the virtual full-crossbar emulator. The design of FIG. 3 which was un-routable using the partial crossbar emulator is shown in FIG. 6 being successfully routed using the virtual full-crossbar emulator.

Routing chip 22 (RC1) is again used to make connection X1, between pins A of logic chips F2 and F3. This is shown in the middle 2 cells of the first column of the table labeled X1-RC1. Connection X2 is made by routing chip 24 (RC2), between pin B of logic chips F1 and F3, and is shown in the second column as X2-RC2. Connection X3 is between pin C of logic chips F1, F3, and uses routing chip 26 (RC3), and is shown in the third column as X3-RC3 while connection X4 between pin D of logic chips F2, F3 uses routing chip 28 (RC4), and is shown in the fourth column as X4-RC4.

The two more connections (X5, X6) that were un-routable with the partial crossbar emulator of FIG. 3 are made using diagonal routing chips 32, 34. Connections X5 and X6 are both between logic chips Fl and F2. However, no column in the table has empty cells for both rows 1 and 2 (Fl and F2). The diagonal connected by diagonal routing chip 32 (RC5) in FIG. 5B can be used to connect F1 and F2, and is labeled X5 This connection X5 uses the unused first cell of column 1, and the unused second cell of column 2. These cells represent pin A of logic chip F1, and pin B of logic chip F2. These pins are not used by column routing chip 22 (RC1) and are thus free or available resources for routing by RC5.

The other connection X6 between F1 and F2 can use diagonal routing chip 34 (RC6). The second cell of column 3, representing pin B of logic chip F2, and the first cell of column 4, representing pin A of logic chip F4, are not used by column routing chips RC3 or RC4. Diagonal routing chip 34 (RC6) is used to connect these pins, as shown by the X6 label in the table. This could also be labeled X6-RC6 for more consistency, but is labeled X6 to highlight the diagonal connection.

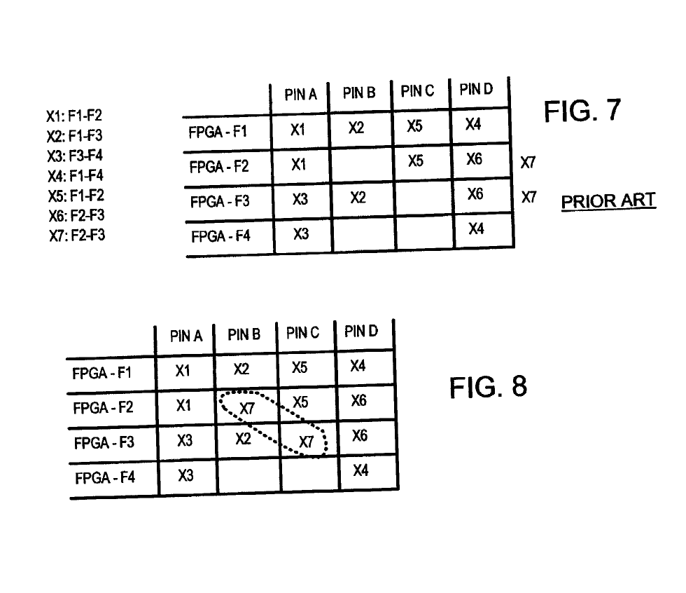

FIG. 7 is an example of a design that is not routable using a prior-art partial crossbar emulator. Seven external connections need to be made among FPGA logic chips F1-F4 and are listed as X1 to X7. Routing chip RC1 can make two connections. Connection X1 is made between pin A of logic chips F1 and F2, while connection X3 is made between pin A of logic chips F3 and F4.

Routing chip RC2 makes only one connection, X2, between pin B of logic chips F1 and F3, as shown in the second column of the table. Routing chip RC3 makes connection X5 between logic chips F1 and F2 using their pin C. Routing chip RC4 also makes two connections: X4 between logic chips F1 and F4, and connection X6 between logic chips F2 and F3. Routing chip RC4 connects to pin D of each logic chip.

Connection X7, between logic chips F2 and F3, cannot be made. There is no single column with empty cells for both rows F2 and F3.

FIG. 8 is a routing table showing successful routing using the virtual fullcrossbar emulator. The column routing chips RC1 to RC4 are connected as described before for FIG. 7, to make connections X1 to X6. The empty cells at column 2, row F2, and column 3, row F3 of FIG. 7 fall in a diagonal. This diagonal of cells connects to diagonal routing chip RC5 (See FIG. 5B).

Diagonal routing chip RC5 is programmed to connect pin B of logic chip F2 with pin C of logic chip F3. Logic chip F2 is programmed to internally route the logic gates connected to this net for connection X7 to its pin B, while logic chip F3 is programmed to internally route a signal from logic gates connected to external net X7 to its pin C.

Diagonal routing chip RC5 does not enable its connection to pin A of logic chip F1, or to pin D of logic chip F4. These pins are already used for connections X1, X4 through routing chips RC1 and RC4. Diagonal routing chip RC5 is programmed to isolate its pins 1 and 4 to logic chips Fl, F4. Isolation can be accomplished by tri-stating or putting these pins of the routing chip RC5 into a high-impedance state.

Thus an additional connection X7 is routed using diagonal routing chip RC5.

Empty cells in the table represent unused pins of the FPGA logic chip. Any unused pins that are connected to RC5 can be used for the additional connection. Empty cells falling along a diagonal can be routed using the diagonal routing chips RC5, RC6.

FIG. 9 is another example of a design that is not routable using the prior-art partial crossbar emulator. Seven external connections to be made among FPGA logic chips F1-F4 are listed as X1 to X7. For example, the third connection X3 is between logic chips F1 and F2. A different connection X7 also connects these same two logic chips F1 and F2, but connects to different logic gates internal to these logic chips and is thus a separate signal net.

Routing chips RC3 and RC4 each make two connections. Connection X1 is made by RC4 between pin D of logic chips F2 and F3, while connection X6 is also made by RC4 between pin D of logic chips F1 and F4. Connection X3 is made by RC3 between pin C of logic chips F1 and F2, while connection X6 is also made by RC3 between pin C of logic chips F3 and F4. These four connections are shown in columns 2 and 3 of the table.

Routing chips RC1 and RC2 each make only one connection. Routing chip RC1 makes connection X2, between pin A of logic chips F2 and F3, as shown in the first column of the table. Routing chip RC2 makes connection X4 between logic chips F1 and F3 using their pin B.

Connection X7, between logic chips F1 and F2, cannot be made. There is no single column with empty cells for both rows F1 and F2. Thus no single column routing chip has extra connections to logic chips F1 and F2. The partial crossbar emulator cannot make the last connection X7.

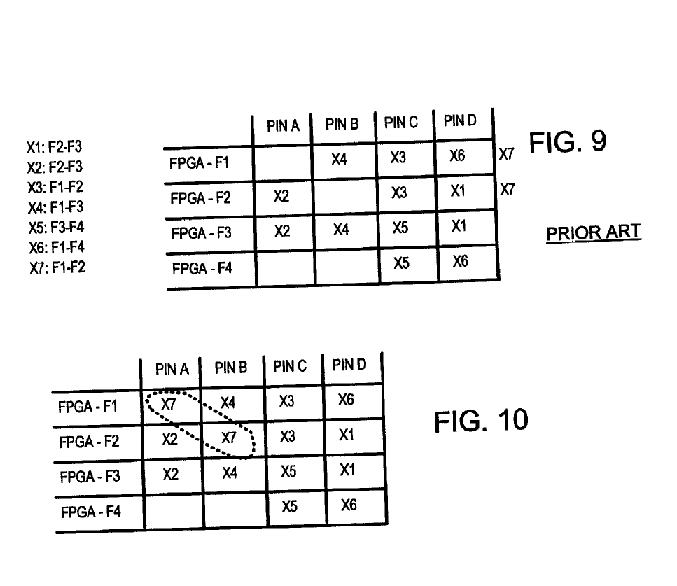

FIG. 10 is a routing table showing the successful routing using the virtual full-crossbar emulator. The column routing chips RC1 to RC4 are connected as described before for FIG. 9, to make connections X1 to X6. The empty cells at column 2, row F2, and column 1, row F1 of FIG. 9 fall in a diagonal. This diagonal of cells connects to diagonal routing chip RC5 (See FIG. 5B).

Diagonal routing chip RC5 is programmed to connect pin B of logic chip F2 with pin A of logic chip F1. Logic chip F2 is programmed to internally route the logic gates connected to this net for connection X7 to its pin B, while logic chip F1 is programmed to internally route a signal from logic gates connected to external net X7 to its pin A. Pins 3 and 4 of routing chip RC5 are not enabled, allowing routing chip RC3 to make the X5 connection, and routing chip RC4 to make the X6 connection. Likewise, column routing chip RC1 must have its pin 1 to F1 disabled, and column routing chip RC2 must have its pin 2 to logic chip F2 disabled to prevent interference with diagonal routing chip RC5 making connection X7. Routing chip RC6 is not used and its outputs are not enabled.

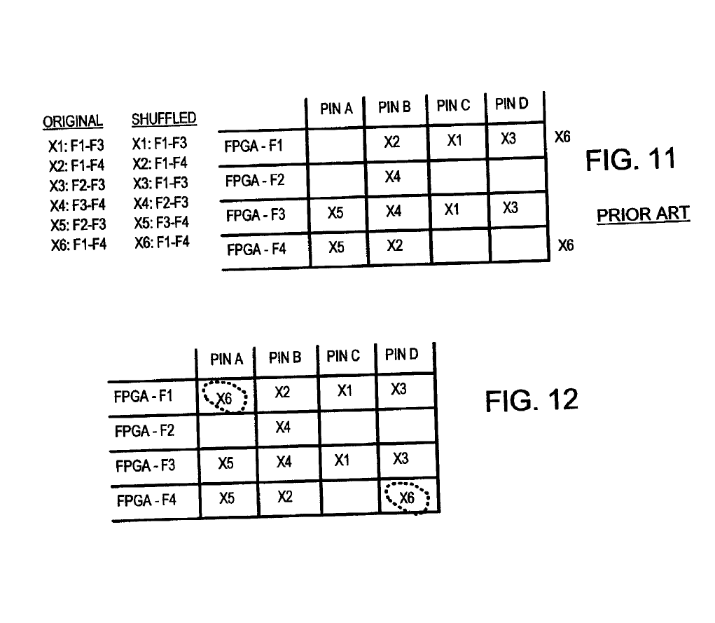

FIG. 11 is an example of shuffling connections to attempt to route a prior-art partial crossbar emulator. Six original connections X1-X6 are listed. Sometimes connections can be re-arranged or shuffled to improve routing or logic-gate usage. Logic gates are implemented on different logic chips, causing different signal nets to appear externally.

In this example, original connections X3, X4, X5 are shuffled. Original connection X3 is changed from F2-F3 to F1-F3, connection X4 is shuffled from F3-F4 to F2-F3, and connection X5 is shuffled from F2-F3 to F3-F4. The table shows that routing chip RC1 connects logic chips F3-F4 for connection X5, routing chip RC3 connects logic chips F1-F3 for connection X1, and routing chip RC4 connects F1-F3 for connection X3.

Routing chip RC2 makes two connections. Logic chips F1-F4 are connected for connection X2, while connection X4 is made between logic chips F2-F3. Despite the shuffling, connection X6 cannot be made, since no column has empty cells for rows F1 and F4.

FIG. 12 shows diagonal routing of the example of FIG. 11. The column routing chips are configured as described for FIG. 11. A connection can be made between logic chips F1 and F4 using diagonal routing chip RC5. Column 1, row F1 is the pin A of logic chip F1, while column 4, row F4 is the D pin of logic chip F4. These pins can be connected together by diagonal routing chip RC5, since they both fall along the diagonal for RC5. Pins 2 and 3 of routing chip RC5 are disabled to prevent interference with routing chips RC2 and RC3.

As these examples show, designs that cannot be routed using the prior-art partial crossbar emulator can be successfully routed with the virtual full-crossbar emulator. The additional diagonal routing chips are used to make connections that otherwise cannot be made with the column routing chips. Since the diagonal routing chips make a second connection to pins of the logic chips, additional logic chips or logic-chip pins are not needed. Additional routing capacity is added without adding logic chips.

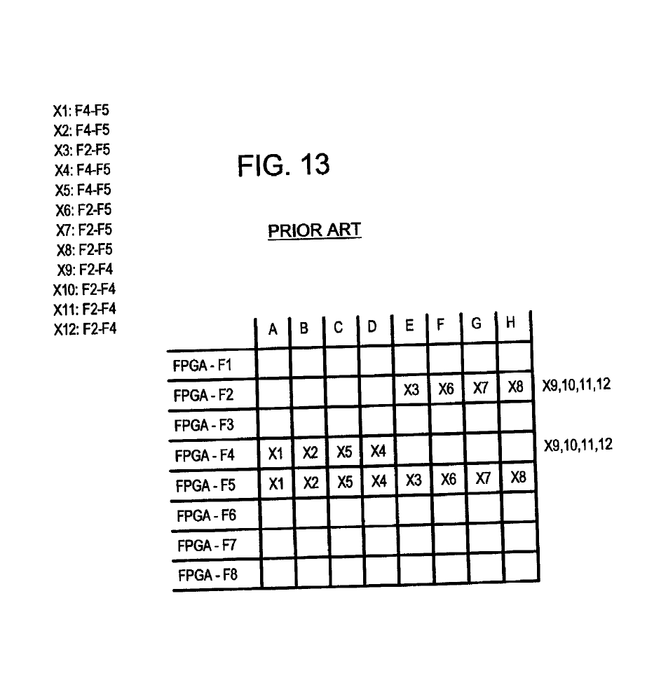

The benefit of the virtual full-crossbar emulator is extendable to higher-capacity logic-emulators. For example, consider a prior-art partial crossbar emulator with 8 FPGA logic chips and 8 routing chips, each with 8 pins. FIG. 13 shows a routing table for a prior-art partial-crossbar emulator with 8 logic chips. Since each FPGA logic chip has 8 pins (A, B, C, D, E, F, G, H), there are 8 columns for each row. As there are now 8 FPGA logic chips (F1-F8), there are now 8 rows in the table.

In this example, there are 12 connections to be made, listed as X1 to X12. These are simple connections between 2 logic chips, although more complex connections among 3 or more logic chips could also occur for some designs. The emulated design uses few logic gates but many wiring nets, such as can occur for some combinatorial designs with many inputs and few outputs. The logic requires only 3 of the 8 FPGA logic chips (F2, F4, F5), although all 8 pins of logic chip F5 are used by external interconnection.

Routing chip RC1 makes connection X1 between pin A of logic chips F4, F5 (column 1). Likewise, routing chips RC2, RC3, and RC4 make connections X2, X5, X4, respectively, between logic chips F4 and F5 (columns 2, 3, 4). Routing chip RC2 connects to pin B, routing chip RC3 connects to pin C, while routing chip RC4 connects to pin D of logic chips F4 and F5.

The remaining four routing chips—RC5, RC6, RC7, and RC8—make connections X3, X6, X7, X8, respectively, between logic chips F2 and F5. Routing chip RC5 connects to pin E, routing chip RC6 connects to pin F, routing chip RC7 connects to pin G, while routing chip RC8 connects to pin H of each of logic chips F4 and F5.

Although other logic chips are unused, connections have been made using all of the routing chips connected to the 3 logic chips in use (F2, F4, F5). Thus there are no more routing resources for the remaining four connections—X9, X10, X11, and X12, which connect between logic chips F2 and F4. The design is not routable using the partial crossbar emulator.

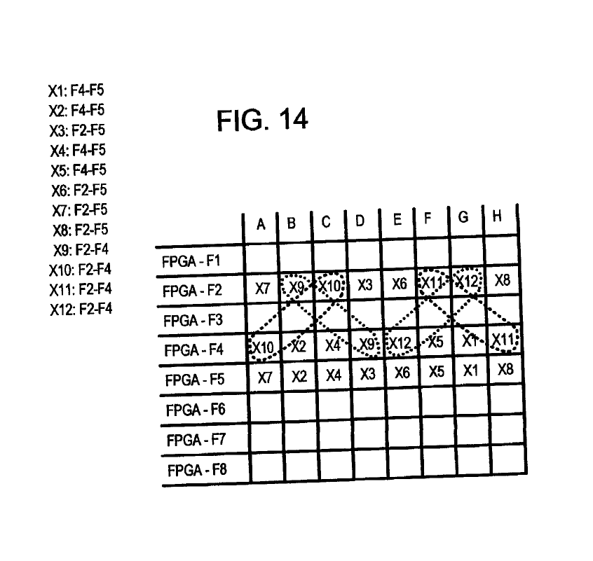

FIG. 14 is a routing table for a virtual full-crossbar emulator with 8 logic chips and 12 routing chips. The same design of FIG. 13 that was unroutable with the partial crossbar emulator is shown in this example.

The connections are moved around somewhat among the 8 columns to locate empty cells where the empty pins can be used by the diagonal routing chips. For example, an empty cell is needed in row F4 of column 1, so connection X1 between F4 and F5 is swapped with connection X7 (between logic chips F2 and F5) in column 7. Other shuffling occur to move empty cells to columns 4, 5, 8 of row F4. Thus connections X7, X3, X6, X8 are made between logic chips F2 and F5 in columns 1, 4, 5, 8, respectively. This opens up empty cells in row F4 for these columns 1, 4, 5, 8, that can be used for diagonal connections.

The remaining connections are X2, X4, X5, X1 between logic chips F4 and F5, in columns 2, 3, 6, 7. These connections have empty cells in row F2 that can be used for the diagonal connections.

While only two diagonal routing chips could be used, the virtual full-crossbar emulator used a half row of diagonal routing chips with the full row of column routing chips. Thus the number of diagonal routing chips is one-half of the number of column routing chips. In this example with 8 logic chips and 8 column routing chips, there are 4 diagonal routing chips.

While four diagonals could be mapped to the 8×8 table in many different ways, in this example the table is split into 2 half-tables. One half-table includes columns 1 to 4, while the other half-table includes columns 5 to 8. In this example, two diagonals are placed in each half-table. The diagonal for routing chip RC9 extends from row F1, column 1, to row F4, column 4. Then the diagonal continues from row F5, column 1, to row F8, column 4. Diagonal routing chip RC9 connects to pin A of logic chips F1, F5, pin B of logic chips F2, F6, pin C of logic chips F3, F7, and pin D of logic chips F4, F8.

The other diagonal in the first half-table (columns 1-4) is a reflection of the diagonal for RC9. The diagonal for routing chip RC10 extends from row F1, column 4, back to row F4, column 1. Then the diagonal continues from row F5, column 4, to row F8, column 1. Diagonal routing chip RC10 connects to pin D of logic chips F1, F5, pin C of logic chips F2, F6, pin B of logic chips F3, F7, and pin A of logic chips F4, F8.

The two diagonal for the other half-table are similar. The diagonal for routing chip RC11 extends from row F1, column 5, to row F4, column 8. Then the diagonal continues from row F5, column 5, to row F8, column 8. Diagonal routing chip RC11 connects to pin E of logic chips F1, F5, pin F of logic chips F2, F6, pin G of logic chips F3, F7, and pin H of logic chips F4, F8. The other diagonal using routing chip RC12 extends from row F1, column 8, to row F4, column 5. Then the diagonal continues from row F5, column 8, to row F8, column 5. Diagonal routing chip RC12 connects to pin H of logic chips F1, F5, pin G of logic chips F2, F6, pin F of logic chips F3, F7, and pin E of logic chips F4, F8.

The remaining 4 connections X9, X10, X11, X12 can be mapped to the 4 diagonal routing chips. Diagonal routing chip RC9 makes connection X9 between logic chips F2 and F4, using the empty cells at row F2, column 2, and row F4, column 4. Likewise, diagonal routing chip RC10 makes connection X10 between logic chips F2 and F4, using the empty cells at row F2, column 3, and row F4, column 1.

In the right-side half-table, diagonal routing chip RC11 makes connection X11 between logic chips F2 and F4, using the empty cells at row F2, column 6, and row F4, column 8. Diagonal routing chip RC12 makes connection X12 between logic chips F2 and F4, using the empty cells at row F2, column 7, and row F4, column 5.

Diagonal routing chip RC9 connects to pin B of logic chip F2, and pin D of logic chip F4. Diagonal routing chip RC10 connects to pin C of logic chip F2, and pin A of logic chip F4. Likewise, diagonal routing chip RC11 connects to pin F of logic chip F2, and pin H of logic chip F4, while diagonal routing chip RC12 connects to pin G of logic chip F2, and pin E of logic chip F4.

Since the diagonal routing chips share physical connections to the same pins of the logic chips with the column routing chips, one of the routing chips needs to disable its electrical connection by isolating the pin. For example, diagonal routing chip RC9 must isolate its pin 5, which is connected to pin A of logic chip F5, which has an active connection (X7) to column routing chip RC1. Likewise, column routing chip RC1 must disable its pin 4 to pin A logic chip F1, since this pin is used by diagonal routing chip RC9 for connection X10.

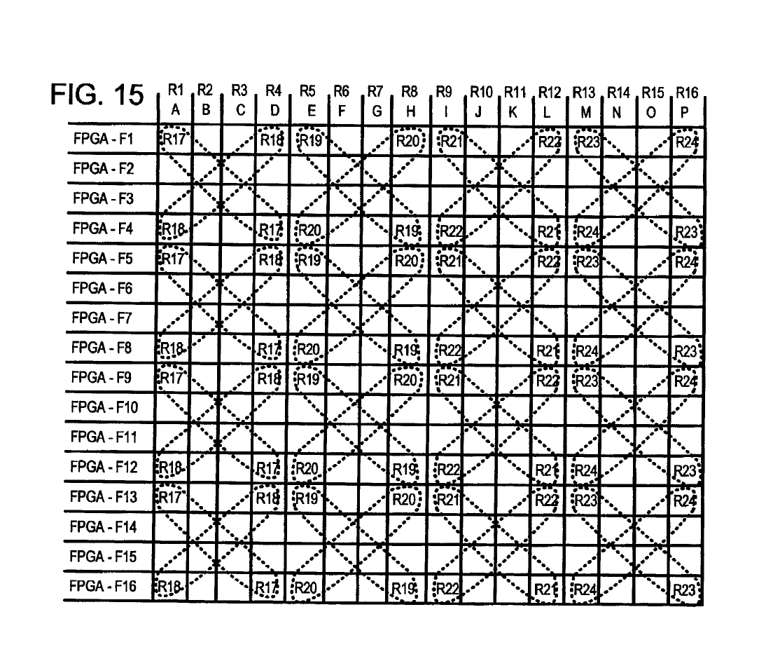

FIG. 15 is a routing table for a virtual full-crossbar emulator having 16 logic chips with 16 pins per chip. A total of 16*16 or 265 I/O pins are available on the 16 logic chips in this larger example. The routing table has one row for each logic chip, labeled as rows F1 to F16.

While a partial crossbar would have 16 column routing chips, the virtual full-crossbar emulator has an additional 8 diagonal routing chips, for a total of 24 routing chips R1 to R24. The column routing chips each connect to the same pin of all 16 FPGA logic chips. Thus column routing chip R1 connects to pin A of each logic chip F1 to F16, and connections made by routing chip R1 are contained in the first column (A) of the table. For example, routing chip R1 could make a first connection between pins A of logic chips F1 and F3, a second connection between pins A of logic chips F2 and F12, a third connection between pins A of logic chips F6, F14, and F15, and a fourth connection between pins A of logic chips F5, F9, F11, and F16.

The column routing chips each make connections within just one of the 16 columns, labeled A to P. For example, column routing chip R14 makes connections in column N, and connects to pins N of all 16 FPGA logic chips F1 to F16. Column routing chip R16 connects to all pins P of the 16 logic chips, and makes connections within column P of the table.

The diagonal routing chips could be mapped to the table in a variety of ways. For example, one diagonal routing chip could connect to pin A of logic chip F1, pin B of logic chip F2, and so on until pin P of logic chip F16. The connections made by this diagonal routing chip would be made in the diagonal from row F1, column A to row F6, column P, all the way across the 16 columns of the table. Another diagonal could be fitted in from row F5, column A, to row F16, column L, and row F1, column M to row F4, column P. These diagonals extend across all 16 columns and are thus full-table diagonals.

Another approach is to split the table into regions, and have the diagonals remain in just one region. This approach is shown in FIG. 15. The table is split into 4 regions, with each region having 4 columns. Each region has 2 diagonals, so a total of 2*4 or 8 diagonal routing chips are used.

In the left-most regions of columns A-D, the mapping of routing chips R17 and R18 are shown. Routing chip R17 starts at row F1, column A, and continues to row F4, column D. It then repeats back to column A, row F5, to column D, row F8. It continues through row F9, column A to row F12, column D, and finally row F13, column A to row F16, column D. Diagonal routing chip R17 connects to pin A of logic chips F1, F5, F9, F13, to pin B of logic chips F2, F6, F10, F14, to pin C of logic chips F3, F7, F11, F15, and to pin D of logic chips F4, F8, F12, F16.

The other diagonal in the first region is formed by diagonal routing chip R18, which connects to pin D of logic chips F1, F5, F9, F13, to pin C of logic chips F2, F6, F10, F14, to pin B of logic chips F3, F7, F11, F15, and to pin A of logic chips F4, F8, F12, F16. Connections can be made using these pins and logic chips, and are formed in the dotted regions for routing chip RI 8 shown in the table. Note that the connections do not have to be with adjacent cells in the table, the connections can be with arbitrary logic chips, and many connections can be made with the same routing chip.

The other three regions likewise each have 2 diagonals, representing 2 diagonal routing chips. Region 2, of columns E-H, has diagonal routing chips R19 and R20, region 3, of columns I-L, has diagonal routing chips R21, R22, and region 4, of columns M-P, has diagonal routing chips R23, R24.

Alternate Embodiments

Several other embodiments are contemplated by the inventors. For example, many different kinds of programmable logic and routing chips can be used. The logic and routing chips may have the same number of pins, or different number of pins, in which case the number of routing chips can be adjusted so that the total number of pins of the routing chips is 1.5 times the number of pins of the logic chips. The ratio of diagonal to column routing chips can vary from 1.5. The logic and routing chips usually have other overhead pins such as power, ground, programming, control, and clock signals that may not be part of the pins used for interconnection. Of course, any advantages and benefits described may not apply to all embodiments of the invention.

Other signals may be connected to all FPGA's, such as global clocks, programming enable signals, and of course power and ground. These are overhead signals to control FPGA programming and are not the emulated signals of the design. The diagonal routing chips may form regional diagonals or full-table diagonals, or a combination of both. The diagonal routing chips could connect to a subset of all the routing chips, rather than to all routing chips. Then the table is split in the row direction into separate regions, rather than in the column direction. The emulator may be split into sub-sections that each is separately routed using a table as in the examples, and then globally routed.

Many separate boards can be plugged together in an emulation system using a backplane bus or a rack. A memory module can be added for some emulation systems. Download control logic can be integrated onto the logic emulation board, or located on a separate board such as a main system board for the hardware emulator. Connectors or plugs can be added to the boards for connection to the host or to the download control logic.

The pins described for the partial and virtual full-crossbar emulators can each represent a subset of several pins rather than a single pin. For example, each of the 4 pins of a FPGA logic chip can represent a subset of 16 pins, for a total of 64 I/O pins from each FPGA logic chip. Each column in the table can be expanded to 16 columns, allowing for 16 connections for the subset, rather than just one connection as described in the simplified examples. Thus 16 connections are allowed between each logic chip and routing chip, rather than just one. Of course, real designs have many, many more connections that the simplified examples, and thus the same problems occur despite the larger number of pins. The table can be computer-readable, such as by a routing program. While it is more difficult to understand the concepts from a larger table, the larger routing tables are easily handled by computer programs in practice.

The routing chips may impose some limitations on the number and location of connections made, or it may allow any number of connections among any pins, up to half the number of pins. The routing chips can include internal busses that are programmably connected to the desired pins to make the connections.

The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. 37 C.F.R. §1.72(b). Any advantages and benefits described may not apply to all embodiments of the invention. When the word “means” is recited in a claim element, Applicant intends for the claim element to fall under 35 USC §112, paragraph 6. Often a label of one or more words precedes the word “means”. The word or words preceding the word “means” is a label intended to ease referencing of claims elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word means are not intended to fall under 35 USC §112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A virtual full-crossbar logic emulator comprising:
a plurality of logic chips with programmable logic gates for programming to emulate a target design for emulation;
logic pins on each of the logic chips, the logic pins for connecting signals in the target design connecting to programmable logic gates in different logic chips;
a row of column routing chips with programmable interconnection, the column routing chips having routing pins coupled to the logic pins of the logic chips; and
a sub-row of diagonal routing chips with programmable interconnection, the diagonal routing chips having routing pins coupled to a subset of the logic pins of the logic chips;
wherein the logic pins of the logic chips include a first group of the logic pins, each logic pin in the first group coupled to a single column routing chip; and a second group of the logic pins, each logic pin in the second group coupled to a column routing chip and coupled to a diagonal routing chip;
whereby connections between logic chips are programmably made by the column routing chips and by the diagonal routing chips.

2. The virtual full-crossbar logic emulator of claim 1 wherein routing pins of column routing chips connected to logic pins in the second group that are also connected to a diagonal routing chip and are being used by a diagonal routing chip for an active connection are disabled in the column routing chip,
whereby routing pins are disabled in the column routing chip when a connected logic pin is used for a connection by a diagonal logic chip.

3. The virtual full-crossbar logic emulator of claim 2 wherein routing pins of diagonal routing chips connected to logic pins that are being used by a column routing chip for an active connection are disabled in the diagonal routing chip,
whereby routing pins are disabled in the diagonal routing chip when a connected logic pin is used for a connection by a column logic chip.

4. The virtual full-crossbar logic emulator of claim 3 wherein each logic chip in the plurality of logic chips comprises a first set of the logic pins, a second set of the logic pins, a third set of the logic pins, and a fourth set of the logic pins;
wherein each column routing chip in the row of column routing chips connects to only one of the sets of the logic pins, each column routing chip connecting to a same set of the logic pins of each of the logic chips and not connecting to other sets of the logic pins; and
wherein each routing chip in the sub-row of diagonal routing chips connects to a different set of the logic pins for different logic chips,
whereby column routing chips connect to a same set of the logic pins while diagonal routing chips connect to different sets of the logic pins.

5. The virtual full-crossbar logic emulator of claim 4 wherein the logic pins are divided into P sets of the logic pins, wherein P is a number of column routing chips, the P sets including the first set, the second set, the third set, and the fourth set;
wherein each column routing chip connects to the logic chips through a different set of the P sets of logic pins.

6. The virtual full-crossbar logic emulator of claim 5 wherein each column routing chip connects to all logic chips.

7. The virtual full-crossbar logic emulator of claim 5 wherein connections between the logic chips are represented by a routing table having rows and columns, each row in the routing table representing a logic chip, each column in the routing table representing a set of the logic pins;
wherein each of the column routing chips is for making connections within a single column in the routing table;
wherein each of the diagonal routing chips is for making connections spanning several columns of the routing table.

8. The virtual full-crossbar logic emulator of claim 7 wherein connections made by diagonal routing chips fall along diagonal lines in the routing table, each diagonal line spanning at least two columns and two rows of the routing table.

9. The virtual full-crossbar logic emulator of claim 8 wherein each diagonal routing chip is coupled to all logic chips;
wherein each diagonal routing chip is coupled to all sets of the logic pins,
whereby the diagonal routing chips fall on diagonal lines that span all columns in the routing table.

10. The virtual full-crossbar logic emulator of claim 8 wherein each diagonal routing chip is coupled to all logic chips;
wherein each diagonal routing chip is coupled to less than all sets of the logic pins,
whereby the diagonal routing chips fall on diagonal lines that span fewer than all columns in the routing table, the diagonal routing chips being within a region of the routing table.

11. The virtual full-crossbar logic emulator of claim 5 wherein the sub-row of the diagonal routing chips comprises fewer routing chips than contained in the row of column routing chips.

12. The virtual full-crossbar logic emulator of claim 11 wherein the sub-row of the diagonal routing chips contains one-half of a number of routing chips in the row of column routing chips,
whereby the sub-row is a half-row.

13. The virtual full-crossbar logic emulator of claim 12 wherein the row of column routing chips contains a same number of chips as the plurality of logic chips while the sub-row of diagonal routing chips contains one-half of a number of chips in the plurality of logic chips.

14. The virtual full-crossbar logic emulator of claim 13 wherein each logic chip comprises a first number of logic pins, and wherein each routing chip also comprises the first number of logic pins.

15. The virtual full-crossbar logic emulator of claim 14 wherein the routing pins of the column routing chips are coupled to all logic pins including the second group of the logic pins;
wherein each logic pin in the second group of the logic pins is coupled both to a routing pin of a column routing chip and to a routing pin of a diagonal routing chip.

16. The virtual full-crossbar logic emulator of claim 5 wherein the logic chips and the routing chips are field-programmable gate arrays (FPGA) chips.

17. The virtual full-crossbar logic emulator of claim 16 wherein the logic chips and the routing chips are re-programmable.

18. A logic emulator comprising:
first logic chip means for emulating logic gates of a target design for emulation, the first logic chip means having first, second, third, and fourth pin means for externally connecting logic gates;
second logic chip means for emulating logic gates of a target design for emulation, the second logic chip means having first, second, third, and fourth pin means for externally connecting logic gates;
third logic chip means for emulating logic gates of a target design for emulation, the third logic chip means having first, second, third, and fourth pin means for externally connecting logic gates;
fourth logic chip means for emulating logic gates of a target design for emulation, the fourth logic chip means having first, second, third, and fourth pin means for externally connecting logic gates;
first column routing chip means, having pin means for coupling to the first pin means of the first, second, third, and fourth logic chip means, for forming programmable connections among the first pin means of the first, second, third, and fourth logic chip means;
second column routing chip means, having pin means for coupling to the second pin means of the first, second, third, and fourth logic chip means, for forming programmable connections among the second pin means of the first, second, third, and fourth logic chip means;
third column routing chip means, having pin means for coupling to the third pin means of the first, second, third, and fourth logic chip means, for forming programmable connections among the third pin means of the first, second, third, and fourth logic chip means;
fourth column routing chip means, having pin means for coupling to the fourth pin means of the first, second, third, and fourth logic chip means, for forming programmable connections among the fourth pin means of the first, second, third, and fourth logic chip means;
first column routing chip means, having pin means for coupling to the first pin means of the first, second, third, and fourth logic chip means, for forming programmable connections among the first pin means of the first, second, third, and fourth logic chip means;
first diagonal routing chip means, having pin means for coupling to the first pin means of the first logic chip means, to the second pin means of the second logic chip means, to the third pin means of the third logic chip means, and to the fourth pin means of the fourth logic chip means, for forming programmable connections among the first, second, third, and fourth pin means of the first, second, third, and fourth logic chip means; and second diagonal routing chip means, having pin means for coupling to the fourth pin means of the first logic chip means, to the third pin means of the second logic chip means, to the second pin means of the third logic chip means, and to the first pin means of the fourth logic chip means, for forming programmable connections among the fourth, third, second, and first pin means of the first, second, third, and fourth logic chip means, w
hereby emulated logic gates of the first, second, third, and fourth logic chip means are programmably connected by column and diagonal routing chips means.

19. The logic emulator of claim 18 wherein the first, second, third, and fourth pin means comprise one or more signal pins.

20. A virtual full-crossbar emulator comprising:
a plurality of L field-programmable gate array (FPGA) logic chips, each logic chip for emulating logic gates and each logic chip having signal pins for externally connecting to other logic chips;
wherein the signal pins comprise P pin sets;
a plurality of P column routing chips, each column routing chip coupled to the L FPGA logic chips using a same one of the P pin sets, each column routing chip for making programmable connections between FPGA logic chips using one of the P pin sets; and
a plurality of P/2 diagonal routing chips, each diagonal routing chip coupled to the L FPGA logic chips using different ones of the P pin sets, each diagonal routing chip for making programmable connections between FPGA logic chips using different ones of the P pin sets;
wherein L and P are integers greater than one,
whereby the programmable connections are made within a pin set using a column routing chip, but made between pin sets using a diagonal routing chip.
